(19) United States
(12) Patent Application Publication
(10) Pub. No.: US 2024/0065250 A1
(43) Pub. Date: Feb. 29, 2024

(54) Equine Shoe with Shaped Cuff

(71) Applicant: Monty L. Ruetenik, Clear Lake Shores, TX (US)

(72) Inventor: Monty L. Ruetenik, Clear Lake Shores, TX (US)

(21) Appl. No.: 18/087,606

(22) Filed: Dec. 22, 2022

Related U.S. Application Data
(60) Provisional application No. 63/402,565, filed on Aug. 31, 2022.

(51) Int. Cl. A01L 5/00

(52) U.S. Cl. CPC A01L 5/00

(57) ABSTRACT

An equine shoe assembly that is an equine shaped shoe cuff structure attached to an equine shoe, preferable a shoe that covers substantially all the underside of a hoof, the cuff being designed to hold the shoe in place on an equine hoof. Additionally the assembly can include an orthotic and/or a pulsing bladder that fits beneath the equine hoof on the inside top of the cuff assembly when the shoe/cuff assembly is employed.

### CROSS-REFERENCE TO RELATED APPLICATION

This application claims the benefit and priority from U. S. Provisional Patent Application 402,565 filed 98/21/20226, the contents and disclosure of both are incorporated herein by reference for all purposes.

### BACKGROUND

### Field of Invention

This invention relates to equine shoes. More specifically, it relates to an equine shaped shoe cuff structure attached to an equine shoe, preferable a shoe that covers substantially all the underside of a hoof, the cuff being designed to hold the shoe in place on an equine hoof. Additionally the assembly can include an orthotic and/or a pulsing bladder that fits beneath the equine hoof on the inside top of the cuff assembly when the shoe/cuff assembly is employed.

### Background

Solid equine shoes are usually attached to equine's hoofs by nailing, gluing or wrapping with casting tape. However, these methods make is difficult to remove the shoe. Nailing, of course, damages the hoof and direct gluing makes it difficult to change the shoe when the hoof grows or otherwise needs changing. Moreover, these traditional attachment means are often inadequate to restrain the forward and/or lateral forces on the shoe when the equine stops or turns.

There have been fabric cuffs proposed and in commercial use that allow the shoe to be attached by gluing the fabric attached to the shoe to the sides and/or top of the hoof. These overcome some of the problem outlined above but are not entirely satisfactory. See for example U.S. Pat. No. 5,699,861.

What is needed is a substantial less flexible cuff that can be permanently or removably attached to the top side of a polymer shoe. The cuff needs to be strong, somewhat flexible and easily attached to the hoof. The cuff should also accommodate an elastomeric orthotic and/or a pulsing bladder. An ideal cuff will be sized to fit individual equine hooves and be easily attachable and removal. The present invention is such a detachable cuff and cuff/shoe assembly.

### SUMMARY OF THE INVENTION

This invention it relates to an equine shoe cuff structure that can be attached to an equine shoe, preferable a shoe that covers substantially all the underside of a hoof, the cuff being designed to hold the shoe in place on an equine hoof. The cuff has a base resembling an ordinary metal horseshoe with an integral raised section on the front that is sloped from the front center to about the midsection (laterally) of the base. Additionally, the invention, in some embodiments, relates to shoe/cuff assemblies comprising an orthotic and/or a pulsing bladder that fits under the equine hoof on top of the shoe when attached to an equine hoof. In some embodiments, the cuff will have circular openings (holes) in the front sidewall to allow access for the cuff structure to be attached, as by screws or nails, to a dual density polymer shoe topside. The holes (openings) also allow adhesive to be injected to secure the cuff structure to an equine hoof.

### BRIEF DESCRIPTION OF DRAWINGS

The accompanying drawings, which are incorporated into and constitute a part of this specification, illustrate one or more embodiments of the present invention and, together with the detailed description, serve by way of illustration and not by limitation to explain the principles and implementations of the invention.

FIG. 1 is an illustration of the top side of a polymer shoe cuff of an embodiment of the invention.

FIG. 2 is an illustration of the bottom side of a polymer shoe cuff of an embodiment of the invention.

FIG. 3 is an illustration of the rear of a polymer shoe cuff of an embodiment of the invention.

FIG. 4 is an illustration of the front of a polymer shoe cuff of an embodiment of the invention.

FIG. 5 is an illustration of perspective view of a polymer shoe cuff of an embodiment of the invention.

FIG. 6 is an illustration of the top side of an elastomeric orthotic pad of an embodiment of the invention.

FIG. 7 is an illustration of the bottom side of an elastomeric orthotic pad of an embodiment of the invention.

FIG. 8 is an illustration of a perspective view of an elastomeric orthotic pad of an embodiment of the invention.

FIG. 9 is an illustration of another perspective view of an elastomeric orthotic pad of an embodiment of the invention.

FIG. 10 is an illustration of the top side of a dual density polymer equine shoe of an embodiment of the invention.

FIG. 11 is an illustration of perspective view of a dual density polymer equine shoe of an embodiment of the invention.

FIG. 12 is an illustration of a top side view of an assembly with a shoe, cuff and orthotic of an embodiment of the invention.

FIG. 13 is an illustration of a rear side perspective view of an assembly with a shoe, cuff and orthotic of an embodiment of the invention.

FIG. 14 is an illustration of a side perspective view of an assembly with a shoe, cuff and orthotic of an embodiment of the invention.

FIG. 15 is an illustration of a front side perspective view of an assembly with a shoe, cuff and orthotic of an embodiment of the invention.

FIG. 16 is an illustration of a top side view of an assembly with a shoe and cuff of an embodiment of the invention.

FIG. 17 is an illustration of a top side perspective view of an assembly with a shoe and cuff of an embodiment of the invention.

FIG. 18 is an illustration of a top side perspective view of an assembly with a shoe and split cuff of an embodiment of the invention.

### DETAILED DESCRIPTION OF THE INVENTION

This invention is an equine shoe cuff and a cuff assembly that comprises a cuff structure and an equine dual density polymer shoe. Optionally the assembly also includes an elastomeric orthotic pad disposed in the cuff structure resting on top side of the polymer shoe, and/or a bladder (for pulsing the hoof) that may be disposed above or below the orthotic or simply placed in the shoe structure without an orthotic.

### The Shoes

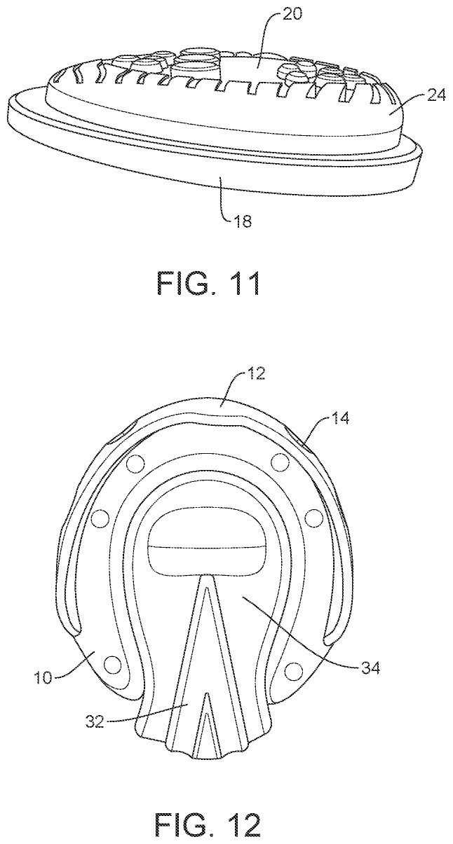

Referring to the drawing, FIGS. 10 and 11 illustrate embodiments of a dual density polymer (two component) equine shoe of an embodiment of the invention. In the FIGS. 10 and 11, the item 18, is a base of hard polymer that forms to top side of the shoe when in use. Component 24 is a sloped softer component of the shoe (as explained further below) and 20 shows one type of patterning for this component.

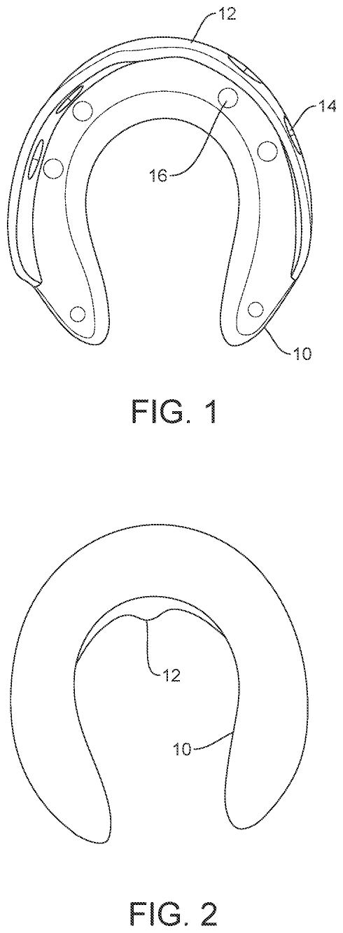

Suitable polymer equine shoes for this assembly are dual density polymer (different densities of a top section and a bottom section) shoes as described in U.S. Pat. No. 10,584,304 issued Feb. 4, 2020. Shoes such as those described in FIG. 1A, through 3A of U.S. Pat. No. 10,548,304 are especially useful as are the shoe described in U.S. D897,052 issued Sep. 22, 2020. The shoes are there described as a solid, dual density, hoof shaped shoe structure designed to substantially cover the entire underside of a hoof. The disclosures of these two patents are incorporated herein by reference for all purposes.

The shoe is sloped on the underside to allow the hoof to roll forward, or to the side, without unnecessary bending, thus allowing an equine to find a comfortable natural position to relieve stress on a sore, injured or diseased hoof. The structure is dual density construction with a relatively thin hard section on the top section and a thicker softer section below. The harder section attaches to the hoof and acts to stabilize the softer lower section. Copper or other solid medical components may be bonded into the top side (side in contact with the hoof when in use). Carbon fiber may also be incorporated in the polymers to strengthen the structure. The disclosure and drawings of U.S. Pat. No. 10,548,304 issued Feb. 4, 2020 and U.S. D897,052 issued Sep. 22, 2020 are incorporated herein by reference for all purposes. The shoes described above are referred to herein as “Dual Density Polymer Shoes”

These dual density polymer (two component) shoes place the load on the center of the hoof rather than the outside wall. It's dual density construction helps increase blood flow to the hoof, reduces strain and pressure on the coffin bone and navicular region, and isolates the concussive force of impact with the ground on the horse's skeletal system, all while providing improved multi-directional traction. This makes them great for aging horses with issues like laminitis, navicular syndrome and ringbone, and they're also perfect for long-term use on all performance horses.

### The Cuff

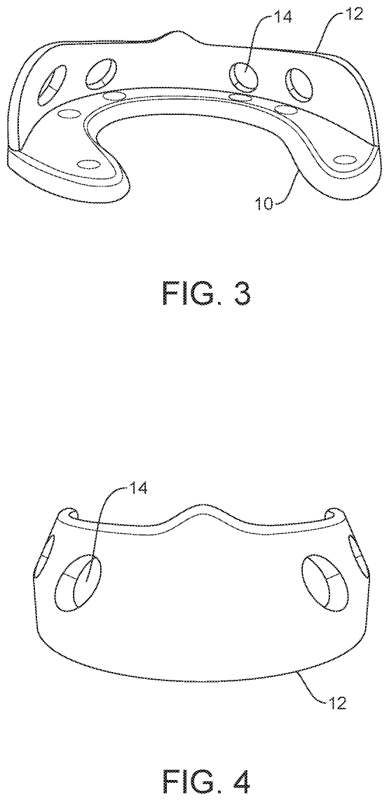

The cuff of embodiments of this invention is illustrated in FIGS. 1-5. This cuff is designed for use with a dual density polymer shoe as described above. As illustrated, the cuff has a base 10 that is shaped like an ordinary metal horseshoe Like an ordinary horseshoe the base of the cuff comprises a circular or semicircular band that form an oval or circular shape that does not meet at the rear but are arranged to have open space between the circular bands or sides. Such a base is shown as item 10 in the Figures. It has a shaped raised front section, 12, (integral with the base) 12, and optionally holes, 14. The holes, when present, will be of about ½ to 1 inch in diameter. The raised front is tapered towards the rear of the base to about half to three quarters height at near, but not at the rear of the base. The cuff is shaped to approximate the underside of an equine hoof. When used in the shoe/cuff assembly, it is shaped and sized to fit on the top side of a dual density polymer shoe. The cuff is made of a relatively stiff polymer, preferably polyurethane.

The cuffs are semi rigid yet can be compressed or expanded laterally to fit the specific shaped outer perimeter of hoof abnormalities as well as to various sized dual density polymer shoes. Carbon fiber may also be incorporated to add strength.

The cuffs can in some embodiments have one to four holes (openings) in the front, which enable a screw gun driver to engage mechanical fasteners to attach the cuff into the shoe. In general, smaller cuff embodiments will have four holes and larger cuff will have five to six.

The holes (openings) also can serve as, “button keys”, to lock in place feature by putting a small amount of tradition hoof adhesive onto the hoof to lock cuff in place yet can be easily removed off the hoof capsule by unlocking (removing) the button keys out of the cuff holes, preferably leaving the buttons attached to the hoof wall. Larger cuffs have six holes to accommodate more button keys.

The adhesive button key easily attaches to the hoof wall (normal farrier industry adhesives such as Vettecc superfast) creating a series of buttons the diameter of the holes on the hoof wall. The interior of the cuff has a smooth finish that the adhesive does not adhere to as well as the more porous hoof wall.

To unlock the cuff from the hoof, the buttons are released out of the cuff holes. Small wedges can be used to pull the buttons out of the cuff holes. Thus, in some embodiments, the button keys remain on hoof wall, which enables the device to simply slip back on after hoof medication or larval treatment etc. When the hoof grows out for next trimming cycle simply grind/rasp off the buttons off the hoof wall while doing a normal hoof trim.

In some embodiments it is desirable to infuse the polymer of the cuff with carbon fibers. The carbon fiber infused into the polymer stiffens up the polymer enabling the cuff to better hold the desired shape once attached to the dual density polymer shoe by either mechanical means or adhesive (or a combination thereof).

The front of the cuff on the center line may have a raised center alignment marker, helping the user to get proper alignment of the shoe mechanics in alignment with the distal limb visually as well as by feel.

The cuff also comprises in some embodiments an elastomeric orthotic disposed between the side of the base of the cuff and resting on the top of the equine shoe.

### The Orthotic Pad

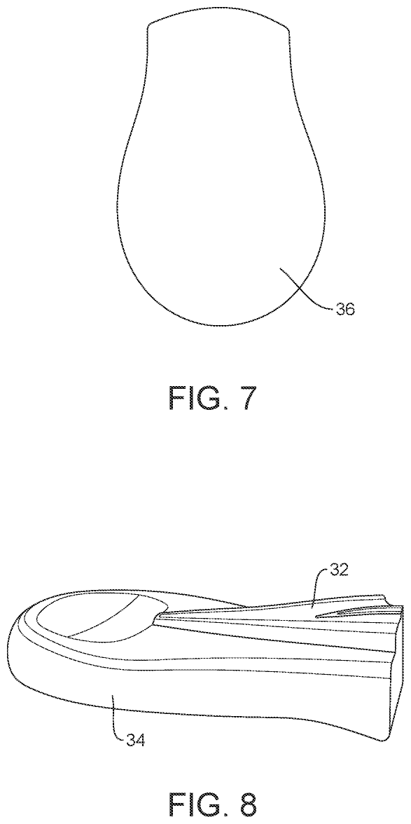

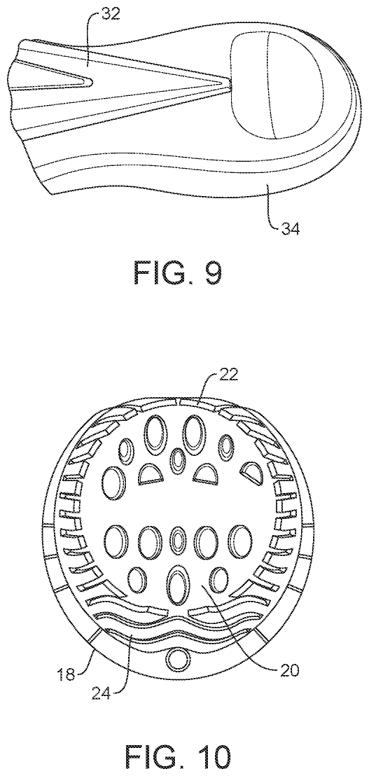

While there may be used any form of cushioning pad in the cuff/shoe assembly, it is in some embodiments, desirable to use an elastomeric orthotic pad. A suitable orthotic pad is illustrated in FIGS. 6 through 9. The pad is desirably shaped to fit in the opening of the base of the cuff, resting on the top of a attached dual density polymer shoe. The composition of the pad is the same as those described in U.S. Pat. No. 9,770,018, issued Sep. 26, 2017, the description of the elastomeric pads therein are incorporated herein by reference. The orthotic pads are also described in U.S. Pat. No. 7,178,321, issued Feb. 20, 2007; U.S. Pat. No. 7,445,051, issued Nov. 4, 2008, D565256, issued Mar. 25, 2008, and U.S. Pat. No. 8,220,231 issued Jul. 17, 2017, all of which appropriate portions are incorporated herein by reference.

The deep gel composition of these described orthotics reaches into the crevices of a horse's foot and massages the frog, helping the natural pumping motion that circulates blood as a horse shifts it weight on its feet. These deep gel orthotic replicates that loading and unloading in nature by pumping the horse's hoof, even when its wearing shoes and standing on hard ground that doesn't conform to his hooves. The volume of the gel, paired with the shoe creates a gel platform that enables the horse to find its most comfortable hoof angle—similar to humans shifting their feet side to side to find comfort when standing.

### The Pulsing Bladder (Pad)

In some embodiments, there can be placed a pulsing bladder above or below the orthotic pad, or on the top side of the shoe (without the orthotic pad) in an assembly (as described below). The pad can suitably be the same as described in U.S. Pat. No. 8,291,835, issued Oct. 23, 2023, which patent and its disclosure are incorporated herein by reference for all purposes. The pulsing action can be the same to pulsing means as described to the above referenced U.S. Pat. No. 8,291,835, issued Oct. 23, 2023. As described in the patent, shoes with pulsing bladders may be placed on one or more of an equine hooves. If place on all four, the pulsing can be designed to simulate an equine's gait. The bladders for the embodiments will be shapes and constructed to fit inside the opening in the bottom of the cuff.

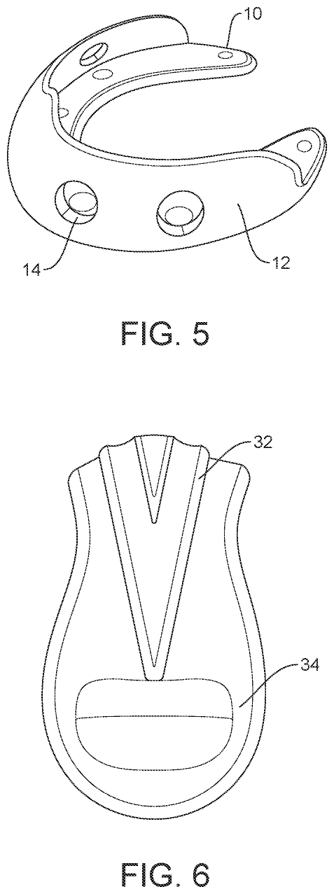

A two-port bladder with two ports is shown in FIGS. 5, 6 and 7 of application Ser. No. 12/581,620 filed Oct. 19, 2009, Publication No. US 2010-0095614, the disclosure and teachings of which are incorporated herein by reference.

### The Cuff/Shoe Assembly

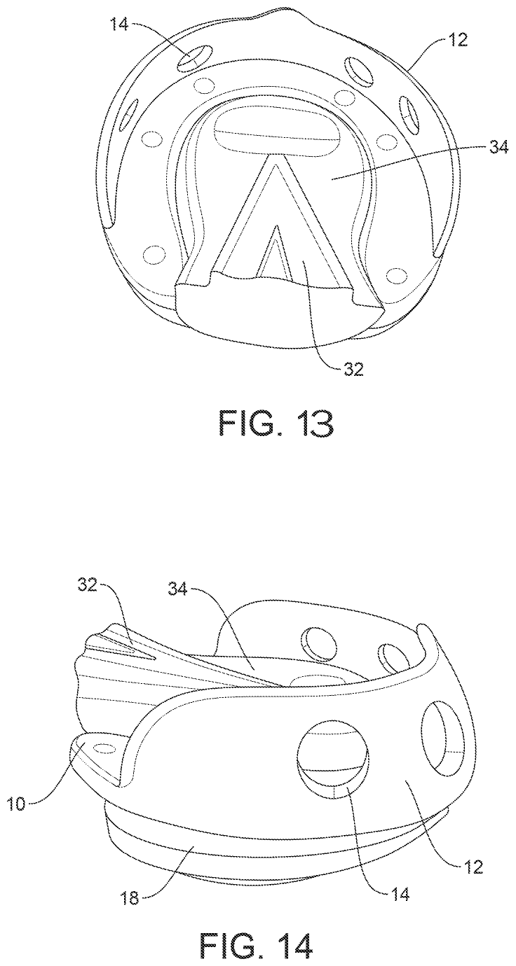

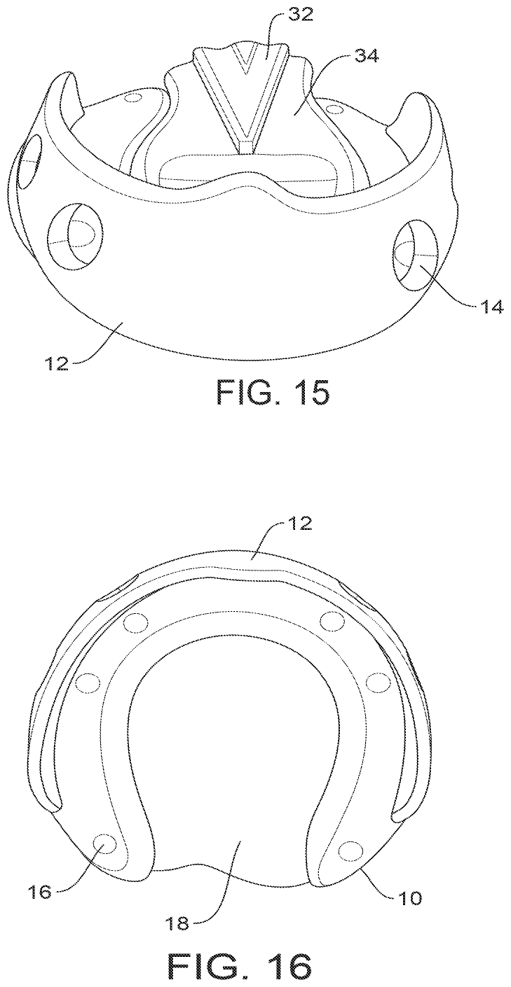

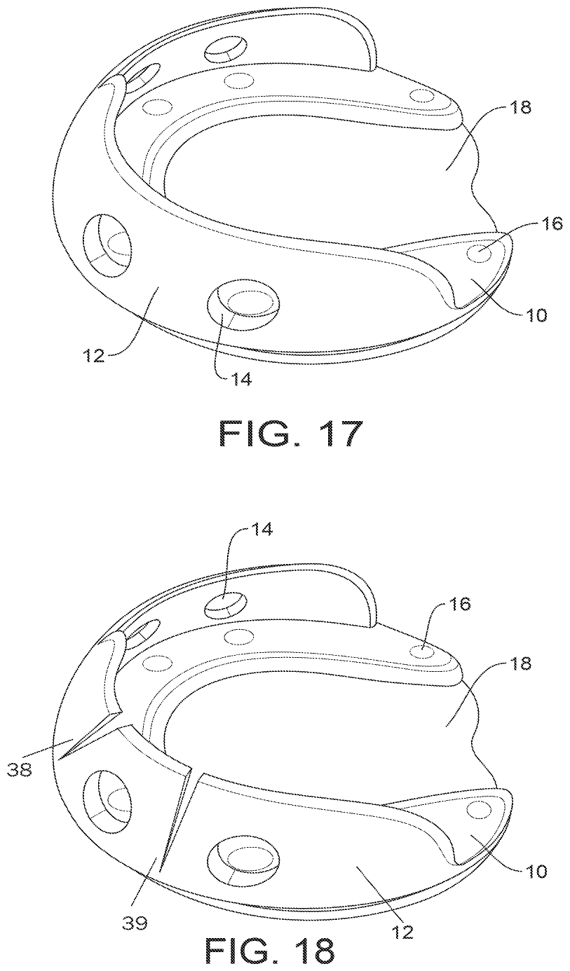

FIGS. 12 to 18 illustrate embodiments of the shoe assembly of the invention. The cuff 12 rests atop the shoe 18. The cuff cane nailed, screwed or attached by adhesive to the shoe, as is expedient for the user. It can also be temporarily attached by wrapping the shoe and cuff together with casting tape or the like. Items 14 are the optional holes in the cuff as described above and 16 is indication of nailing or screwing location, for convenience. Item 10 is the cuff base. FIG. 17 is a top view, 18 is a perspective view.

FIGS. 12 to 18 show the same assemble by one that has an elastomeric orthotic, 34, disposed atop the shoe between the cuff legs, 10. Item 32 is the optional frog support on the orthotic. The orthotic is shaped to fit into the space between the cuff legs (bands), 10. Item 18 is the top side of a polymer shoe as described above.

FIG. 18 shows the cuff 12 with slits, 38 and 39, in the front of the cuff. These slits allow the font of the cuff to be more flexible to make fitting tighter and more secure. These slits are especially helpful where the front of the hoof is not quite the shape of the cuff opening and thus allows a better fit. The slits are shown as V shaped but simple straight slits are also suitable as are any other shape.

### CONCLUSION

While the present invention has been illustrated by a description of various embodiments and while these embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative apparatus and method, and illustrative example shown and described. Accordingly, departures may be made from such details without departing from the spirit or scope of applicant's general inventive concept. The specification and drawings are, accordingly, to be regarded in an illustrative rather than a restrictive sense. Therefore, unless otherwise specified, the scope of the invention should be limited only by the appended claims.

1. A semi rigid equine shoe assembly cuff comprising;
a cuff structure shaped like a metal horseshoe, comprising a base comprising and a shape wall with a front and rear attached to the base, the wall having raised front tapered towards the rear of the base to about half to three quarters height of the front of the wall at near, but not at the rear of the base.

2. The cuff of claim 1 wherein the cuff is polyurethane.

3. The cuff of claim 1 wherein the cuff base comprises circular or semicircular bands that form an oval or circular shape, that do not meet at the rear but are arranged to have open space between the circular bands or sides.

4. The cuff of claim 1 wherein there are one to two slits in the front wall.

5. An equine shoe/cuff assembly comprising;
a cuff structure shaped like an metal horseshoe, comprising a base and a shape wall with a front and rear attached to the base, the wall having raised front 1 tapered towards the rear of the base to about half to three quarters height of the front of the wall at near, but not at the rear of the base, attached to the top side of a polymer shoe.

6. The shoe/cuff assembly of claim 5 wherein the polymer shoe comprise solid, dual density, hoof shaped shoe structure designed to substantially cover the entire underside of a hoof.

7. The shoe/cuff assembly of claim 5 also comprising an elastomeric orthotic disposed between the sides of the base of the cuff and resting on the top of the equine shoe.

8. The shoe/cuff assembly of claim 5 also comprising a pulsing bladder disposed between the sides of the base of the cuff and resting on the top of the equine shoe.

9. The shoe/cuff assembly of claim 5 comprising both an elastomeric pad and a pulsing bladder disposed between the sides of the base of the cuff and resting on the top of the equine shoe.

10. The shoe/cuff assembly of claim 5 wherein the cuff and base is polyurethane.

11. The shoe/cuff assembly of claim 5 wherein the cuff and base contain carbon fibers.

12. The shoe/cuff assembly of claim 5 wherein the cuff one to two slits in the front wall.
